(19) United States
(12) Patent Application Publication
(10) Pub. No.: US 2023/0203613 A1
(43) Pub. Date: Jun. 29, 2023

(54) Low-Cost Non-Oriented Electrical Steel Plate With Extremely Low Aluminum Content and Manufacturing Method Therefor

(71) Applicant: Baoshan Iron & Steel Co., Ltd., Shanghai (CN)

(72) Inventors: Feng Zhang, Shanghai (CN); Kanyi Shen, Shanghai (CN); Zhenyu Zong, Shanghai (CN); Guobao Li, Shanghai (CN); Xianshi Fang, Shanghai (CN)

(21) Appl. No.: 17/927,165

(22) PCT Filed: May 25, 2021
(86) PCT No.: PCT/CN2021/095717

§ 371 Date: Nov. 22, 2022

(30) Foreign Application Priority Data
May 29, 2020 (CN) 202010472318.5

(51) Int. Cl. C21D 8/12; C22C 38/06; C21C 7/06; C21D 1/74; C22C 38/02; C22C 38/04; C22C 38/00; C21D 9/46

(52) U.S. Cl. CPC C21D 8/1222; C22C 38/06; C21C 7/06; C21D 1/74; C22C 38/02; C22C 38/04; C22C 38/002; C22C 38/001; C22C 38/008; C21D 8/1233; C21D 9/46; C21D 2201/00

(57) ABSTRACT

Disclosed is a low-cost non-oriented electrical steel plate with an extremely low aluminum content, which plate comprises the following chemical elements in percentage by mass: 0.003% or less of C, 0.1%-1.2% of Si, 0.1%-0.4% of Mn, 0.01%-0.2% of P, 0.003% or less of S, 0.001% or less of Al, 0.003%-0.01% of O, 0.003% or less of N, and 0.005%-0.05% of Sn, with the condition Si²/P: 0.89-26.04 being satisfied. In addition, further disclosed is a method for manufacturing the non-oriented electrical steel plate. The method comprises steps of: (1) smelting; (2) continuous casting; (3) hot rolling: wherein a hot rolled plate is subjected to soaking and heat preservation by means of residual heat of hot rolled steel coils, rather than being subjected to normalizing treatment or cover furnace annealing after coiling; (4) primary cold rolling; and (5) continuous annealing. In the non-oriented electrical steel plate of the present invention, reasonable chemical ingredients and process designs are used, and the non-oriented electrical steel plate not only has excellent economy, but also has the properties of high magnetic induction and low iron loss.

### TECHNICAL FIELD

The present invention relates to a steel plate and a method for manufacturing the same, in particular to a non-oriented electrical steel plate and a method for manufacturing the same.

### BACKGROUND

The direction of grains inside a non-oriented electrical steel plate is not unique, and the non-oriented electrical steel plate is a functional material with excellent electromagnetic properties. For a long time, the non-oriented electrical steel plate has been developing in two directions: first, high-efficiency and high-grade steel with high manufacturing cost and complex production process, but excellent electromagnetic properties and mechanical properties; and second, medium- and low-grade steel with low manufacturing cost, simple production process and excellent electromagnetic properties and mechanical properties.

According to statistics, due to different application occasions, the number of non-oriented electrical steel plates of medium and low grades accounts for 70% or more of all non-oriented electrical steel plates. Therefore, it is of great practical significance to study how to produce the non-oriented electrical steel plates of medium and low grades more economically and conveniently, and further improve its cost performance. At the same time, considering that the non-oriented electrical steel plates of medium and low grades are mostly used in small and medium-sized motors, EI iron cores, small generators, etc., the user market is constantly demanding to reduce the iron loss of steel plates, and at the same time, it is more urgent to improve the magnetic induction of the steel plates, in order to reduce the copper loss of iron cores more effectively.

In addition, studies have shown that in the electromagnetic performance indicators of the non-oriented electrical steel plates, the iron loss and magnetic induction are mutually restricted, and it is difficult to achieve low iron loss and high magnetic induction at the same time, unless the normalizing treatment or cover furnace annealing treatment is performed on hot rolled steel plates, but this will greatly increase the manufacturing cost of a finished steel plate.

In recent years, a large number of scientific and technological workers have made many beneficial attempts on how to effectively improve the electromagnetic properties of the non-oriented electrical steel plates while reducing their manufacturing costs without performing normalizing treatment or cover furnace annealing treatment on hot rolled plates.

Chinese patent document CN101992210A, published on Mar. 30, 2011, and entitled “Method for producing aluminum-free steel grade of cold-rolled non-oriented silicon steel”, discloses a method for producing an aluminum-free steel grade of cold-rolled non-oriented silicon steel, and points out that by controlling Al≤0.0010% and the content of residual elements that are likely to form nitrides, adopting low-temperature heating and temperature-controlled rolling for hot rolling, primary cold rolling or secondary cold rolling with intermediate annealing, and implementing comprehensive performance control measures such as wet hydrogen decarburization, recrystallization temperature annealing, etc., mass production of high-efficiency aluminum-free cold-rolled non-oriented silicon steel is achieved at a lower production cost under the existing equipment conditions, and its electromagnetic properties are better than that of cold rolled non-oriented silicon steel of a same grade produced by a conventional process, the iron loss is reduced by about 0.4 W/kg on average, and the magnetic induction is increased by 0.2 T on average. A specific control method is as follows: the content of residual aluminum brought in during the alloying process including deoxidized aluminum, materials and refractory materials is controlled, Al is controlled to be 0.0010% or less, and Si deoxidation is used in the refining and deoxidation process; the nitrogen content during smelting and the content of residual elements which are likely to form nitrides are controlled, and the content of N, Ti, Nb, and V is controlled to be 0.0020% or less, respectively; the hot rolling adopts low-temperature heating and finish rolling to implement temperature-controlled rolling, that is, rolling in a ferrite single-phase region, and a two-phase precipitation state is controlled; the hot rolled steel billet heating temperature is 1000-1150° C., the initial rolling temperature is 950° C. or more, the finish rolling temperature is 840° C. or more, and the coiling temperature is 690° C. or more; cold rolling adopts primary cold rolling or secondary cold rolling with intermediate annealing for rolling to the thickness of a finished product; and annealing adopts cover furnace continuous annealing for wet hydrogen decarburization and recrystallization temperature annealing. Provided are an unoriented electrical steel plate and a manufacturing method thereof. The unoriented electrical steel plate includes the following components in percentage by weight: 0.03-0.15% of C, 0.15% or less of Si, 1.0-1.8% of Mn, 0.025% or less of P, 0.015% or less of S, 0.08-0.18% of Ti, 0.02-0.07% of Nb, 0.02-0.10% of Al, 0.010% or less of N, and the balance of iron and residual content.

Chinese patent document CN101306434A, published on Nov. 19, 2008, and entitled “Preparation method for low-carbon low-silicon aluminum-free semi-process non-oriented electrical steel”, discloses a preparation method for producing low-carbon low-silicon aluminum-free semi-process non-oriented electrical steel. The process steps are as follows: a hot rolling raw material composition design requires that a chemical composition of a cast slab satisfies: 0.005% or less of C, 0.1-1.0% of Si, 0.35% or less of Mn, 0.08% or less of P, 0.01% or less of S, 0.008% or less of N, 0.015% or less of O, and the balance of Fe and unavoidable impurities; and the semi-process non-oriented electrical steel with excellent magnetic properties is obtained from the cast slab by hot charging, hot rolling, critical deformation cold rolling and user stress relief annealing. The semi-process non-oriented electrical steel is characterized in that the cast slab heating temperature is 900-1150° C., the finish rolling temperature is required to be 10-50° C. lower than the Ar3 transformation point, and the thickness of a hot-rolled plate is 2.0-2.5 mm; intermediate annealing is performed at 600-850° C. for 1-2 min under an intermediate annealing atmosphere of a mixed gas of H₂ and N₂, wherein the proportion of H₂ is 10-40%, and no humidification and decarburization is required, and a recrystallization rate after intermediate annealing is guaranteed to be 40% or more; the critical deformation cold rolling means that a steel strip after the intermediate annealing is subjected to critical deformation cold rolling to 0.5 mm at a reduction of 0.5-15%, wherein the hardness of a steel plate after the critical deformation cold rolling is 130-180HV; and the user stress relief annealing means that a cold-rolled product after the critical deformation is subjected to punching and lamination, and then is subjected to user stress relief annealing at a temperature of 700-850° C. for 1-2 h, wherein the annealing atmosphere is required to be a mixed gas of H₂ and N₂, the proportion of H₂ is 10-40%, and a cooling mode is slow cooling, requiring cooling to 450° C. at a cooling rate of 10-100° C./h, and then furnace cooling is performed to obtain a final desired product. The semi-process non-oriented electrical steel has the advantages that the final product has excellent magnetic properties, P_{15/50}=3.35-5.05 W/kg, and B₅₀₀₀=1.69-1.76 T. The cast slab does not contain alloying elements such as Al, Sn, Sb, Cu, Cr, Ni, B, rare earth, etc., and the production cost is greatly reduced. A larger critical reduction is used, and the annealing process is optimized, so that the produced finished product has better magnetic properties.

### SUMMARY

One of the objects of the present invention is to provide a low-cost non-oriented electrical steel plate with an extremely low aluminum content. By optimizing the chemical composition of steel, the non-oriented electrical steel plate reduces the quality of a special alloy for deoxidation and alloying of RH refining by means of the technical features of the extremely low aluminum content in the steel and the proper oxidizability included in the steel and slag, so as to greatly reduce the manufacturing cost of the steel and effectively control the alloy cost. Compared with conventional products of a same grade, the iron loss P_{15/50} of the non-oriented electrical steel plate is reduced by 0.2-0.8 W/kg on average, and the magnetic induction B₅₀ of the non-oriented electrical steel plate is increased by 0.01-0.04 T on average. That is, compared with the existing conventional products of the same grade, the non-oriented electrical steel plate of a specific grade of the present invention has the advantages that the iron loss P_{15/50} is reduced by 0.2-0.8 W/kg on average, and the magnetic induction B₅₀ is increased by 0.01-0.04 T on average, and the non-oriented electrical steel plate not only has excellent economy, but also has the characteristics of high magnetic induction and low iron loss. Wherein a reference value of the above electromagnetic properties is that of a common non-oriented electrical steel plate in the existing user market. Among the electromagnetic properties of a grade B50A1300, the iron loss P_{15/50} is generally 5.5-6.5 W/kg, and the magnetic induction B₅₀ is generally 1.74-1.76 T; among the electromagnetic properties of a conventional grade B50A800, the iron loss P_{15/50} is generally 5.0-5.5 W/kg, and the magnetic induction B₅₀ is generally 1.71-1.73 T; and among the electromagnetic properties of a conventional grade B50A600, the iron loss P_{15/50} is generally 3.9-4.5 W/kg, and the magnetic induction B₅₀ is generally 1.68-1.71 T.

In order to achieve the above object, the present invention provides a low-cost non-oriented electrical steel plate with an extremely low aluminum content, including the following chemical elements in percentage by mass:

0.003% or less of C, 0.1%-1.2% of Si, 0.1%-0.4% of Mn, 0.01%-0.2% of P, 0.003% or less of S, 0.001% or less of Al, 0.003%-0.01% of O, 0.003% or less of N, and 0.005%-0.05% of Sn, with the condition Si²/P: 0.89-26.04 being satisfied.

Further, the non-oriented electrical steel plate according to the present invention includes the following chemical elements in percentage by mass:

0.003% or less of C, 0.1%-1.2% of Si, 0.1%-0.4% of Mn, 0.01%-0.2% of P, 0.003% or less of S, 0.001% or less of Al, 0.003%-0.01% of O, 0.003% or less of N, 0.005%-0.05% of Sn, and the balance of Fe and other unavoidable impurities, with the condition Si²/P: 0.89-26.04 being satisfied.

In the non-oriented electrical steel plate of the present invention, a design principle of chemical elements is as follows:

C: In the non-oriented electrical steel plate according to the present invention, carbon is one of strong aging forming elements. When the content of C element in steel is higher than 0.003%, the C element is easily bonded with Nb, V, Ti, etc. to form a large number of fine inclusions, resulting in a significant increase in the loss of a finished steel plate. Therefore, in the non-oriented electrical steel plate of the present invention, the mass percentage of C is controlled to be C≤0.003%. In the non-oriented electrical steel plate of the present invention, the lower the C element content controlled, the better, specifically, the mass percentage of C is controlled to be 0<C≤0.0030%.

Si: In the non-oriented electrical steel plate according to the present invention, Si element can significantly increase the resistivity of a material. However, it should be noted that if the content of the Si element in steel is less than 0.1%, the iron loss of the finished steel plate cannot be effectively reduced; and if the content of the Si element in the steel is higher than 1.2%, the magnetic induction of the finished steel plate will be significantly deteriorated. Therefore, in the non-oriented electrical steel plate of the present invention, the mass percentage of Si is controlled to be 0.1%-1.2%.

Mn: In the non-oriented electrical steel plate according to the present invention, Mn element can be bonded with S element to form MnS, thereby effectively improving the magnetic properties of the finished steel plate. In order to ensure that the Mn element can effectively play a role, 0.1% or more of Mn needs to be added to the steel, but it should be noted that the content of the Mn element should not be too high. If the content of the Mn element in the steel is higher than 0.4%, a recrystallization texture of the finished steel plate will be destroyed significantly. Therefore, in the non-oriented electrical steel plate of the present invention, the mass percentage of Mn is controlled to be 0.1%-0.4%.

P: In the non-oriented electrical steel plate according to the present invention, P element can significantly improve the strength of a material. When the content of the P element in the steel is lower than 0.01%, the strength of the finished steel plate cannot be effectively improved, while if the content of the P element in the steel is higher than 0.2%, the cold rolling rollability will be significantly reduced. Therefore, in the non-oriented electrical steel plate of the present invention, the mass percentage of P is controlled to be 0.01%-0.2%.

S: In the non-oriented electrical steel plate according to the present invention, the content of S element should not be too high. When the content of the S element in the steel is higher than 0.003%, the number of inclusions such as MnS and Cu₂S will be significantly increased, which will hinder the growth of grains and deteriorate the magnetic properties of the finished steel plate. Therefore, in the non-oriented electrical steel plate of the present invention, the mass percentage of S is controlled to be 0<S≤0.003%. In the non-oriented electrical steel plate of the present invention, the lower the S element content controlled, the better, specifically, the mass percentage of S is controlled to be 0<S≤0.003%.

Al: In the non-oriented electrical steel plate according to the present invention, the content of Al element in the steel should not be too high. When the Al content in the steel is higher than 0.001%, a large amount of AlN harmful inclusions will be formed, which will significantly deteriorate the magnetic properties of the finished steel plate. Therefore, in the non-oriented electrical steel plate according to the present invention, the mass percentage of Al is controlled to be Al≤0.001%. In the non-oriented electrical steel plate of the present invention, the lower the Al element content controlled, the better, specifically, the mass percentage of Al is controlled to be 0<Al≤0.0010%.

In some preferred embodiments, the mass percentage of Al can be controlled to be Als0.0005%.

O: In the non-oriented electrical steel plate according to the present invention, when the content of O element in the steel is less than 0.003%, it is not conducive to the control of the content of Al and Ti, and if the content of the O element in the steel is higher than 0.01%, a large number of oxide inclusions will be formed, which will deteriorate the magnetic properties of the finished steel plate. Therefore, in the non-oriented electrical steel plate of the present invention, the mass percentage of O is controlled to be 0.003%-0.01%.

In some preferred embodiments, the mass percentage of O can be controlled to be 0.045%-0.007%.

N: In the non-oriented electrical steel plate according to the present invention, the content of N element in the steel should not be too high. When the content of the N element in the steel exceeds 0.003%, the Nb, V, Ti, and Al inclusions of N will increase significantly, which hinders the growth of grains, and deteriorates the magnetic properties of the finished steel plate. Therefore, in the non-oriented electrical steel plate of the present invention, the mass percentage of N is controlled to be N≤0.003%. In the non-oriented electrical steel plate of the present invention, the lower the N element content controlled, the better, specifically, the mass percentage of N is controlled to be 0<C≤0.003%.

Sn: In the non-oriented electrical steel plate according to the present invention, Sn is a grain boundary segregation element. An appropriate amount of beneficial element Sn added to the steel can improve grain boundary segregation and improve a microscopic beneficial texture during hot rolling. When the content of Sn element in the steel is less than 0.005%, the segregation effect cannot be effectively obtained, and if the content of the Sn element in the steel exceeds 0.05%, grain refinement will caused, and the magnetic properties of the finished steel plate will be deteriorated. Therefore, in the non-oriented electrical steel plate of the present invention, the mass percentage of Sn is controlled to be 0.005%-0.05%.

In some preferred embodiments, the mass percentage of Sn can be controlled to be 0.005%-0.02%.

In addition, in the non-oriented electrical steel plate according to the present invention, while controlling the content of a single chemical element, the Si element and the P element are also controlled to satisfy the condition Si²/P: 0.89-26.04, wherein both Si and P in the formula represent the numbers before the percent signs of the mass percentages of the corresponding elements. It should be noted that the properties of the Si element and the P element are similar, which can significantly improve the resistivity of the material and reduce the iron loss of the finished steel plate, but at the same time will deteriorate the magnetic induction of the finished steel plate. In terms of improving the mechanical strength of the finished steel plate, the P element has a very good remarkable effect, but it will deteriorate the cold rolling rollability under the condition of high Si content. Therefore, in view of the electromagnetic properties and mechanical properties of the finished steel plate, Si²/P is controlled to be 0.89-26.04 in the non-oriented electrical steel plate of the present invention.

In some preferred embodiments, Si²/P can be controlled to be 0.89-16.67 for better implementation.

In addition, in the non-oriented electrical steel plate according to the present invention, it should noted that unavoidable impurities in the steel include Nb, V, Ti, Ca, Mg and REM. Wherein REM is a rare earth element, which may also be referred to simply as RE.

Further, the non-oriented electrical steel plate according to the present invention includes 0.0005% or less of Al.

Further, the non-oriented electrical steel plate according to the present invention includes 0.045-0.007% of O.

Further, the non-oriented electrical steel plate according to the present invention includes 0.005-0.02% of Sn.

Further, in the non-oriented electrical steel plate according to the present invention, Si²/P is 0.89-16.67.

Further, in the non-oriented electrical steel plate according to the present invention, compared with conventional products of a same grade, the iron loss P_{15/50} of the non-oriented electrical steel plate is reduced by 0.2-0.8 W/kg on average, and the magnetic induction B₅₀ of the non-oriented electrical steel plate is increased by 0.01-0.04 T on average. Further, the non-oriented electrical steel plate of the present invention has a thickness of 0.5±0.1 mm.

Accordingly, another object of the present invention is to provide a method for manufacturing the low-cost non-oriented electrical steel plate with the extremely low aluminum content, the manufacturing method is simple in production process and low in manufacturing cost, and compared with conventional products of the same grade, the non-oriented electrical steel plate manufactured by the manufacturing method has the advantages that the iron loss P_{15/50} is reduced by 0.2-0.8 W/kg on average, and the magnetic induction B₅₀ is increased by 0.01-0.04 T on average, and the non-oriented electrical steel plate has the characteristics of high magnetic induction and low iron loss.

In order to achieve the above object, the present invention proposes a method for manufacturing the non-oriented electrical steel plate, including the steps of:
(1) smelting;
(2) continuous casting;
(3) hot rolling: wherein a hot rolled plate is subjected to soaking and heat preservation by means of residual heat of hot rolled steel coils, rather than being subjected to normalizing treatment or cover furnace annealing after coiling;
(4) primary cold rolling; and
(5) continuous annealing.

In the manufacturing method according to the present invention, the hot rolling process mainly includes: slab heating, rough rolling, finish rolling and coiling processes. The normalizing treatment or cover furnace annealing refers to a process of performing intermediate annealing on hot rolled coils after hot rolling and before cold rolling, in order to improve the electromagnetic properties of the finished product. In the present invention, in step (3), the hot rolled plate is subjected to soaking and heat preservation by means of the residual heat of hot rolled steel coils, rather than being subjected to normalizing treatment or cover furnace annealing after coiling, which can effectively promote the segregation of a trace element Sn, improve the recrystallization structure of the hot rolled steel plate and promote the grain size growth, thus realizing the effect of replacing or supplementing normalizing annealing or cover furnace annealing. In addition, this operation can also effectively simplify the process, reduce the production burden and manufacturing difficulty, and reduce the production cost.

Further, in the manufacturing method of the present invention, in step (1), ferrophosphorus, ferrosilicon and ferromanganese are added in sequence during deoxidation and alloying of RH refining.

In the method for manufacturing the non-oriented electrical steel plate according to the present invention, in step (1), ferrophosphorus, ferrosilicon and ferromanganese are added in sequence during deoxidation and alloying of RH refining. That is, at the end of RH refining, ferrophosphorus, ferrosilicon and ferromanganese are added to molten steel to remove free oxygen in the steel, and elemental components are added according to the requirements of the present invention. In this way, the molten steel is in an aerobic state, Al, Ti, Nb, V, Ca, Mg, REM, etc. in ferrophosphorus and ferrosilicon will rapidly undergo oxidation and reduction reactions, and large particle oxides will be successively generated and floated into top slag, so that the cleanliness of the steel will not be degraded. Therefore, after a lot of experimental researches, the control requirements for some harmful elements of ferrophosphorus and ferrosilicon have been effectively reduced, which can greatly reduce the production cost of steelmaking. Wherein ferrophosphorus, ferrosilicon and ferromanganese refer to alloys containing P, Si, and Mn, and their composition percentages are not limited, as long as the composition of the steel plate formed after the addition meets the above content requirements.

In addition, it should be noted that the addition amount of ferrosilicon needs to consider two aspects: on one hand, ferrosilicon is added according to a chemical component P to ensure that Si²/P is controlled to be 0.89-26.04; and on the other hand, ferrosilicon is added according to a chemical component O to ensure that under the condition of the extremely low aluminum content, the O content in the steel is adjusted by means of Si deoxidation, so as to prevent the O content from being too low or too high. When the addition amount of ferrosilicon is too large, the deoxidation ability is strong, the O content in the steel is low, and a large amount of deoxidation products SiO₂ generated enters the slag, which will lead to the reduction of Al, Ti, Nb, V, Ca, Mg, REM and other elements to enter the steel again; when the addition amount of ferrosilicon is too small, the deoxidation ability is weak, the O content in the steel is too high, and during the final continuous casting, with the continuous reduction of the temperature of the molten steel, a large number of small-sized secondary deoxidation products SiO₂ are generated again due to supersaturation, which cannot be floated and removed at this time, remains in the steel and provides a core for the precipitation of MnS inclusions during subsequent hot rolling. Therefore, it is necessary to add ferrosilicon according to the chemical component O to ensure that the O content in the steel is strictly controlled to be 0.003%-0.01%. The abbreviation of the above-mentioned continuous casting is CC, and casting refers to casting the molten steel into a continuously cast billet.

Further, in the manufacturing method of the present invention, Al≤0.1% and/or Ti≤0.03% in the ferrosilicon.

Further, in the manufacturing method according to the present invention, in step (3), the initial rolling temperature is controlled to be 1050-1150° C., the finish rolling temperature is controlled to be 650-950° C., the coiling temperature is controlled to be 650-850° C., the soaking and heat preservation temperature is controlled to be 650-850° C., and the heat preservation time is controlled to be at least 10 s.

In the above solution, in step (3), controlling the soaking and heat preservation temperature to be 650-850° C. can effectively promote the segregation of the trace element Sn, so as to improve the recrystallization structure of the hot rolled steel plate and promote the grain size growth. The heat preservation time is controlled to be at least 10 s, which can be suitably extended to enlarge the improvement effect, if the temperature conditions allow. For example, further, the heat preservation time is 10 s to 60 h, and even further the heat preservation time may be controlled to be within 24 h, for example 2h to 24 h.

Further, in the manufacturing method according to the present invention, in step (3), rough rolling and finish rolling are completed in 2 to 8 passes. One pass refers to once rolling and 2-8 passes refers to rolling for 2-8 times.

Further, in the manufacturing method according to the present invention, in step (5), the annealing is performed at 650-950° C. under an annealing atmosphere of a mixed gas of H₂ and N₂, wherein a volume proportion of H₂ is 20-60%. Nitrogen will contain a small amount of oxygen, which will easily lead to oxidation and blackening of the surface of the steel plate. Hydrogen is added mainly to avoid oxidation of the surface of strip steel. The effect of hydrogen in the above volume proportion is better, and the cost can be controlled within a reasonable range.

Compared with the prior art, the low-cost non-oriented electrical steel plate with the extremely low aluminum content and the manufacturing method therefor according to the present invention have the following advantages and beneficial effects:
by optimizing the chemical composition design of steel, the low-cost non-oriented electrical steel plate with the extremely low aluminum content reduces the quality of the special alloy for deoxidation and alloying of RH refining by means of the technical features of the extremely low aluminum content in the steel and the proper oxidizability included in the steel and slag, so as to greatly reduce the manufacturing cost of the steel and effectively control the alloy cost. Compared with conventional products of the same grade, the iron loss P_{15/50} of the non-oriented electrical steel plate is reduced by 0.2-0.8 W/kg on average, and the magnetic induction B₅₀ of the non-oriented electrical steel plate is increased by 0.01-0.04 T on average, achieving the characteristics of high magnetic induction and low iron loss while having good economy.

In addition, the manufacturing method of the present invention is simple in production process and low in manufacturing cost, and by controlling the process conditions, especially the hot rolling process, the hot rolled plate is controlled to be subjected to soaking and heat preservation by means of the residual heat of the hot rolled steel coils, rather than being subjected to normalizing treatment or cover furnace annealing after coiling, so that the trace element Sn in the steel can be segregated, and the effects of improving the recrystallization structure of the hot rolled steel plate and promoting the grain size growth can be achieved.

### BRIEF DESCRIPTION OF THE DRAWINGS

FIG. 1 schematically shows the relationship between the oxygen content in a non-oriented electrical steel plate according to the present invention and the iron loss P_{15/50} of a finished steel plate.

FIG. 2 is a microstructure diagram of a hot rolled steel plate in Example 2.

FIG. 3 is a microstructure diagram of a hot rolled steel plate in Comparative example 2.

FIG. 4 is a microstructure diagram of a finished non-oriented electrical steel plate in Example 3.

FIG. 5 is a microstructure diagram of a finished steel plate in Comparative example 3.

### DETAILED DESCRIPTION

The low-cost non-oriented electrical steel plate with the extremely low aluminum content and the manufacturing method therefor according to the present invention will be further explained and described below in connection with the specific examples and the drawings. However, the explanation and description do not constitute an improper limitation to the technical solution of the present invention.

### Examples 1-6 and Comparative Examples 1-6

Table 1 lists the mass percentages of chemical elements in the non-oriented electrical steel plates in Examples 1-6. It should be noted that unavoidable impurities in steel grades mainly include: Nb, V, Ti, Ca, Mg and REM.

TABLE 1
(%, the balance Fe and other unavoidable impurities)

| | Chemical element | | | | | | | | | |
|---|---|---|---|---|---|---|---|---|---|---|
| Steel grade | C | Si | Mn | P | S | Al | O | N | Sn | Si²/P |
| Example 1 | 0.0009 | 0.28 | 0.37 | 0.08 | 0.0024 | 0.0001 | 0.0091 | 0.0013 | 0.05 | 0.98 |
| Example 2 | 0.0023 | 0.94 | 0.16 | 0.12 | 0.0019 | 0.0003 | 0.0057 | 0.0008 | 0.005 | 7.36 |
| Example 3 | 0.0019 | 1.13 | 0.23 | 0.09 | 0.0016 | 0.0002 | 0.0032 | 0.0011 | 0.04 | 14.19 |
| Example 4 | 0.0011 | 0.29 | 0.37 | 0.05 | 0.0011 | 0.0008 | 0.0054 | 0.0028 | 0.015 | 1.68 |
| Example 5 | 0.0022 | 0.65 | 0.28 | 0.18 | 0.0022 | 0.0005 | 0.0041 | 0.0017 | 0.045 | 2.35 |
| Example 6 | 0.0028 | 1.01 | 0.21 | 0.04 | 0.0009 | 0.0007 | 0.0064 | 0.0020 | 0.02 | 25.50 |

The non-oriented electrical steel plates in Examples 1-6 according to the present invention are all manufactured by the following steps:
(1) smelting: after molten iron from a blast furnace and an appropriate amount of scrap steel are smelted in a converter, decarburization, deoxidization and alloying are completed in sequence during RH refining, and then a qualified slab is cast. Ferrophosphorus, ferrosilicon and ferromanganese are added in sequence during deoxidation and alloying of RH refining, wherein Al≤0.10% and/or Ti≤0.03% in the ferrosilicon.
(2) continuous casting;
(3) hot rolling: wherein the initial rolling temperature is controlled to be 1050-1150° C., the finish rolling temperature is controlled to be 650-950° C., the coiling temperature is controlled to be 650-850° C., the soaking and heat preservation temperature is controlled to be 650-850° C., and the heat preservation time is controlled to be at least 10 s, rough rolling and finish rolling are completed in 2 to 8 passes, and a target thickness of hot rolling is 1.2-2.8 mm; a hot rolled plate is subjected to soaking and heat preservation by means of residual heat of hot rolled steel coils, rather than being subjected to normalizing treatment or cover furnace annealing after coiling; and after the hot rolling is completed, the hot rolled steel coils are pickled;
(4) primary cold rolling: once rolling to a target thickness; and
(5) continuous annealing: wherein the annealing is performed at 650-950° C. for 180 s or less under an annealing atmosphere of a mixed gas of H₂ and N₂, wherein a volume proportion of H₂ is 20%-60%.

Tables 2-1 and 2-2 list the specific process parameters of the manufacturing method of the non-oriented electrical steel plates in Examples 1-6. Wherein rough rolling and finish rolling passes in Table 2-2 represent the rolling times of rough rolling and finish rolling, respectively, for example, in Example 1, 4+7 means that rough rolling is completed in 4 passes, and finish rolling is completed in 7 passes.

TABLE 2-1

| | Step (1) |
|---|---|
| Number | Ferrosilicon quality |
| Example 1 | Al ≤ 0.1%, Ti ≤ 0.03%, P ≤ 0.05% |
| Example 2 | Al ≤ 0.10%, Ti ≤ 0.03%, P ≤ 0.05% |
| Example 3 | Al ≤ 0.10%, Ti ≤ 0.03%, P ≤ 0.05% |
| Example 4 | Al ≤ 0.10%, Ti ≤ 0.03%, P ≤ 0.05% |
| Example 5 | Al ≤ 0.10%, Ti ≤ 0.03%, P ≤ 0.05% |
| Example 6 | Al ≤ 0.10%, Ti ≤ 0.03%, P ≤ 0.05% |

TABLE 2-2

| | | | | | | | | Step (5) | | |
|---|---|---|---|---|---|---|---|---|---|---|
| | Step (3) | | | | | | | | | Volume |
| | | | | Soaking | | Rough | Target | | | proportion |
| | Initial | Finish | | and heat | | rolling | thickness | | | of H₂ in |
| | rolling | rolling | Coiling | preservation | Heat | and finish | of hot | Annealing | Annealing | annealing |
| | temperature | temperature | temperature | temperature | preservation | rolling | rolling | temperature | time | atmosphere |
| Number | (° C.) | (° C.) | (° C.) | (° C.) | time | passes | (mm) | (° C.) | (s) | (%) |
| Example 1 | 1085 | 883 | 792 | 715 | 25 s | 4 + 7 | 2.6 | 810 | 15 | 30 |
| Example 2 | 1120 | 864 | 702 | 653 | 12 h | 4 + 7 | 2.0 | 730 | 20 | 35 |
| Example 3 | 1147 | 687 | 661 | 651 | 44 h | 4 + 7 | 2.8 | 900 | 25 | 55 |
| Example 4 | 1132 | 943 | 679 | 667 | 12 h | 4 + 7 | 1.5 | 680 | 60 | 40 |
| Example 5 | 1109 | 747 | 712 | 673 | 60 s | 4 + 7 | 2.3 | 760 | 35 | 45 |
| Example 6 | 1064 | 793 | 737 | 655 | 6 h | 4 + 7 | 1.8 | 950 | 20 | 50 |

Table 3 lists the mass percentages of chemical elements in the non-oriented electrical steel plates in Comparative examples 1-6.

TABLE 3
(%, the balance Fe and other unavoidable impurities)

| | Chemical element | | | | | | | | | |
|---|---|---|---|---|---|---|---|---|---|---|
| Steel grade | C | Si | Mn | P | S | Al | O | N | Sn | Si2/P |
| Comparative | 0.0022 | 0.41 | 0.62 | 0.06 | 0.0035 | 0.01 | 0.0038 | 0.0008 | 0 | 2.80 |
| example 1 | | | | | | | | | | |
| Comparative | 0.0027 | 1.35 | 0.36 | 0.04 | 0.0022 | 0.0008 | 0.0053 | 0.0016 | 0.15 | 45.56 |
| example 2 | | | | | | | | | | |
| Comparative | 0.0014 | 0.05 | 0.82 | 0.05 | 0.0051 | 0.0007 | 0.0007 | 0.0023 | 0.02 | 0.05 |
| example 3 | | | | | | | | | | |
| Comparative | 0.0021 | 0.29 | 0.19 | 0.05 | 0.0011 | 0.40 | 0.0022 | 0.0028 | 0.07 | 1.68 |
| example 4 | | | | | | | | | | |
| Comparative | 0.0018 | 0.92 | 0.22 | 0.04 | 0.0022 | 0.0022 | 0.0125 | 0.0017 | 0.045 | 21.16 |
| example 5 | | | | | | | | | | |
| Comparative | 0.0008 | 0.15 | 0.35 | 0.04 | 0.0009 | 0.022 | 0.0019 | 0.0020 | 0.12 | 0.56 |
| example 6 | | | | | | | | | | |

Table 4 lists the specific process parameters of the manufacturing method of the non-oriented electrical steel plates in Comparative examples 1-6.

TABLE 4

| | | | | | | | | Step (5) | | |
|---|---|---|---|---|---|---|---|---|---|---|
| | Step (3) | | | | | | | | | Volume |
| | | | | Soaking | | Rough | Target | | | proportion |
| | Initial | Finish | | and heat | | rolling | thickness | | | of H₂ in |
| | rolling | rolling | Coiling | preservation | Heat | and finish | of hot | Annealing | Annealing | annealing |
| | temperature | temperature | temperature | temperature | preservation | rollin | rolling | temperature | time | atmosphere |
| Number | (° C.) | (° C.) | (° C.) | (° C.) | time | passes | (mm) | (° C.) | (s) | (%) |
| Comparative | 995 | 631 | 683 | 547 | 25 s | 2 + 7 | 2.4 | 970 | 25 | 65 |
| example 1 | | | | | | | | | | |
| Comparative | 1027 | 857 | 904 | 872 | 12 h | 4 + 7 | 2.6 | 620 | 5 | 20 |
| example 2 | | | | | | | | | | |
| Comparative | 1000 | 620 | 582 | 349 | 60 h | 2 + 7 | 2.0 | 1000 | 40 | 40 |
| example 3 | | | | | | | | | | |
| Comparative | 1183 | 820 | 631 | 583 | 0 | 6 + 7 | 2.0 | 650 | 10 | 0 |
| example 4 | | | | | | | | | | |
| Comparative | 1200 | 952 | 723 | 623 | 26 h | 4 + 7 | 1.8 | 500 | 25 | 10 |
| example 5 | | | | | | | | | | |
| Comparative | 1035 | 982 | 924 | 901 | 0 | 4 + 7 | 3.5 | 600 | 5 | 0 |
| example 6 | | | | | | | | | | |

It should be noted that the steel plates in Comparative examples 1-6 are manufactured by using only conventional process conditions, rather than the manufacturing process according to the present invention, and the steel plates in Comparative examples 1-6 correspond to those in Examples 1-6, respectively. Wherein the non-oriented electrical steel plate in Example 1 corresponds to steel of a national grade B50A1300 in Comparative example 1, the non-oriented electrical steel plate in Example 2 corresponds to steel of a national grade B50A800 in Comparative example 2, the non-oriented electrical steel plate in Example 3 corresponds to steel of a national grade B50A470 in Comparative example 3, the non-oriented electrical steel plate in example 4 corresponds to steel of a national grade B50A1300 in Comparative example 4, the non-oriented electrical steel plate in Example 5 corresponds to steel of a national grade B50A800 in Comparative example 5, and the non-oriented electrical steel plate in Example 6 corresponds to steel of a national grade B50A470 in Comparative example 6.

The non-oriented electrical steel plates with a final target thickness of 0.5±0.1 mm obtained by cold rolling in Examples 1-6 and the steel plates in Comparative examples 1-6 are subjected to various performance tests, and the obtained test results are listed in Table 5.

Table 5 lists the performance test results of the non-oriented electrical steel plates in Examples 1-6 as well as the steel plates in Comparative examples 1-6. Wherein, iron loss performance test: an iron loss performance test is performed by using an Epstein square based on the national standard GB/T 3655-2008 at a constant temperature of 20° C., wherein a specimen size is 30 mm×300 mm, a target mass is 0.5 kg, and a test parameter is P_{15/50}.

Magnetic induction performance test: a magnetic induction performance test is performed by using the Epstein square based on the national standard GB/T 3655-2008 at a constant temperature of 20° C., wherein a specimen size is 30 mm×300 mm, a target mass is 0.5 kg, and a test parameter is B₅₀.

TABLE 5

| | | Iron loss | Magnetic |
|---|---|---|---|
| | | P_{15/50} | induction B₅₀ |
| Number | Grade | (W/kg) | (T) |
| Example 1 | B50A1300 | 5.4 | 1.79 |
| Example 2 | B50A800 | 4.4 | 1.74 |
| Example 3 | B50A600 | 3.2 | 1.71 |
| Example 4 | B50A1300 | 5.2 | 1.78 |
| Example 5 | B50A800 | 4.5 | 1.75 |
| Example 6 | B50A600 | 3.1 | 1.72 |
| Comparative | B50A1300 | 5.8 | 1.75 |
| example 1 | | | |
| Comparative | B50A800 | 5.0 | 1.72 |
| example 2 | | | |
| Comparative | B50A600 | 4.0 | 1.70 |
| example 3 | | | |
| Comparative | B50A1300 | 6.0 | 1.74 |
| example 4 | | | |
| Comparative | B50A800 | 5.2 | 1.72 |
| example 5 | | | |
| Comparative | B50A600 | 3.9 | 1.68 |
| example 6 | | | |

As can be seen from Table 5, there are obvious differences in iron loss P_{15/50} and magnetic induction B₅₀ between the steel plates manufactured by using conventional process conditions in Comparative examples 1-6 and the non-oriented electrical steel plates in Examples 1-6. When the electromagnetic performance test density is 7.85 g/cm³, the iron loss P_{15/50} in Example 1 is reduced by 0.4 W/kg, and the magnetic induction B₅₀ in Example 1 is increased by 0.04 T compared with those in Comparative example 1, which is mainly because in Comparative example 1, the Al content is as high as 0.01%, which has exceeded the upper limit of 0.001% in the claims of the present invention, and hot rolled steel coils are subjected to soaking and heat preservation at only 547° C., which does not meet the control range of 650-850° C.; when the electromagnetic performance test density is 7.80 g/cm³, the iron loss P_{15/50} in Example 2 is reduced by 0.6 W/kg, and the magnetic induction B₅₀ in Example 2 is increased by 0.02 T compared with those in Comparative example 2, which is mainly because in Comparative example 2, the design of the content of Si and P does not match, resulting in that Si²/P is as high as 45.56, which has exceeded the upper limit of 26.04, and hot rolled steel coils are subjected to soaking and heat preservation at a temperature that is as high as 872° C., which does not meet the control range of 650-850° C.; when the electromagnetic performance test density is 7.70 g/cm³, the iron loss P_{15/50} in Example 3 is reduced by 0.8 W/kg, and the magnetic induction B₅₀ in Example 3 is increased by 0.01 T compared with those in Comparative example 3, which is mainly because in Comparative example 3, the Si content is too low, so that Si²/P is only 0.05, which cannot meet the lower control limit of 0.89, and hot rolled steel coils are subjected to soaking and heat preservation at only 349° C., which does not meet the control range of 650-850° C.; when the electromagnetic performance test density is 7.85 g/cm³, the iron loss P_{15/50} in Example 4 is reduced by 0.8 W/kg, and the magnetic induction B₅₀ in Example 4 is increased by 0.04 T compared with those in Comparative example 4, which is mainly because in Comparative example 4, the composition design of Al-containing steel is used, and as high as 0.4% of Al is added to the steel, resulting in the O content being lower than the lower control limit of 0.003% in the present invention and only 0.0022%, and at the same time, hot rolled steel coils are subjected to soaking and heat preservation at 583° C., which does not meet the control range of 650-850° C., and the soaking and heat preservation time is 0, which is lower than the design requirement of 10 s in the present invention; when the electromagnetic performance test density is 7.80 g/cm³, the iron loss P₁₅/o in Example 5 is reduced by 0.7 W/kg, and the magnetic induction B₅₀ in Example 5 is increased by 0.03 T compared with those in Comparative example 5, which is mainly because in Comparative example 5, the Al content is 0.0022%, which exceeds the upper control limit of 0.001% in the present invention, and the O content is as high as 0.0125%, which exceeds the design upper limit of 0.01% in the present invention; and when the electromagnetic performance test density is 7.70 g/cm³, the iron loss P_{15/50} in Example 6 is reduced by 0.8 W/kg, and the magnetic induction B₅₀ in Example 6 is increased by 0.04 T compared with those in Comparative example 6, which is mainly because in Comparative example 6, the O content is only 0.0019%, which is lower than the design lower limit of 0.003% in the present invention, and when hot-rolled steel coils are subjected to soaking and heat preservation, although soaking and heat preservation are performed at a temperature that is as high as 900° C., the soaking and heat preservation time is 0, which is lower than the lower limit of the design requirement of 10 s in the present invention.

Thus, it can be seen that the non-oriented electrical steel plates in the examples of the present invention have excellent properties through the reasonable chemical composition design and process design. Compared with conventional products of the same grade, the iron loss P_{15/50} of the non-oriented electrical steel plate is reduced by 0.2-0.8 W/kg on average, and the magnetic induction B₅₀ of the non-oriented electrical steel plate is increased by 0.01-0.04 T on average, achieving the characteristics of high magnetic induction and low iron loss while having good economy.

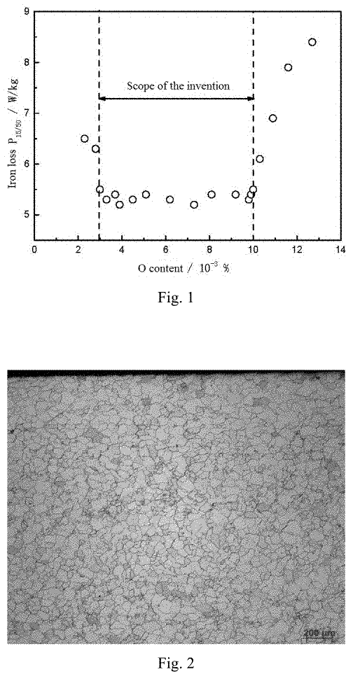

FIG. 1 schematically shows the relationship between the oxygen content in a non-oriented electrical steel plate according to the present invention and the iron loss P₁₅/o of a finished steel plate.

As shown in FIG. 1, FIG. 1 schematically shows the relationship between the oxygen content and the iron loss P_{15/50} of the finished steel plate, wherein the steel plate shown in FIG. 1 is manufactured with a steel grade of a national standard grade B50A1300 as a standard, and other ingredients of the steel plate in FIG. 1 are all within the defined scope of the ingredients of the present invention, and the manufacturing methods therefor are also within the scope of the present invention. That is, the steel plate in FIG. 1 includes the following chemical elements in percentageby mass: 0.003% or less of C, 0.1%-1.2% of Si, 0.1%-0.4% of Mn, 0.01%-0.2% of P, 0.003% or less of S, 0.001% or less of Al, 0.003% or less of N, 0.005%-0.05% of Sn, and the balance of Fe and other unavoidable impurities, with the condition Si²/P: 0.89-26.04 being satisfied. And the manufacturing method for the steel plate includes the steps of: (1) smelting; (2) continuous casting; (3) hot rolling: wherein a hot rolled plate is subjected to soaking and heat preservation by means of residual heat of hot rolled steel coils, rather than being subjected to normalizing treatment or cover furnace annealing after coiling; (4) primary cold rolling; and (5) continuous annealing.

As can be seen from FIG. 1, the iron loss of the finished steel plate is closely related to the oxygen content in the steel. When the oxygen content is lower than 30 ppm, the iron loss of the steel plate will exceed 6.0 W/kg, and the lower the oxygen content, the higher the iron loss of the steel plate; and when the oxygen content is 30-100 ppm, the iron loss of the steel plate is generally lower, and the control effect can be stabilized at 5.5 W/kg or below; after the oxygen content is higher than 100 ppm, with the continuous increase of the oxygen content, the iron loss of the steel plate increases monotonously and rapidly, and when the oxygen content reaches 130 ppm, the iron loss of the steel plate can even reach 8.5 W/kg, which is much higher than the iron loss of the steel plate corresponding to the low oxygen content.

FIG. 2 is a microstructure diagram of a hot rolled steel plate in Example 2.

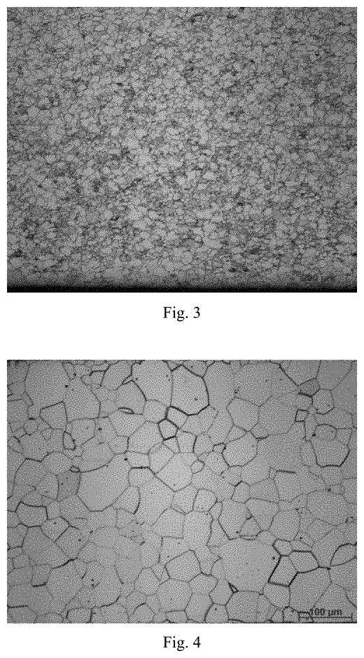

FIG. 3 is a microstructure diagram of a hot rolled steel plate in Comparative example 2.

As shown in FIGS. 2 and 3, the hot rolled steel plate corresponding to Example 2 can achieve complete recrystallization, the grains are uniform in size and coarse, and the average grain size can reach 80 μm, while the corresponding hot rolled steel plate corresponding to Comparative example 2 does not achieve complete recrystallization, recrystallization is only achieved at a position close to about 5% of the upper and lower surface of the hot rolled steel plate, and the middle of the steel plate is a fibrous incompletely recrystallized structure. The size of grains that can be recrystallized is relatively small, with an average of less than 50 μm.

FIG. 4 is a microstructure diagram of a finished non-oriented electrical steel plate in Example 3.

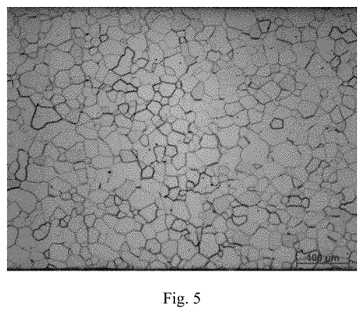

FIG. 5 is a microstructure diagram of a finished steel plate in Comparative example 3.

It can be seen in connection with FIGS. 4 and 5 that for Example 3, the microstructure of the finished strip steel is dominated by coarse equiaxed grains, the size of the long and short axes between the grains is close, the shape is regular, and the average recrystallization size is 75 μm. In Comparative example 3 of the same grade, there is a phenomenon that the grains cannot grow up effectively, the fine grains show local clusters and segregation, and the rest of the equiaxed grains that can complete recrystallization normally show the phenomenon of small grain size and uneven distribution.

It should be noted that the above-mentioned examples are only specific examples of the present invention. Obviously, the present invention is not limited to the above examples, and similar variations or modifications made therewith can be directly derived or can be easily thought of by those skilled in the art from the contents disclosed in the present invention, and all belong to the protection scope of the present invention.

In addition, the combination of the technical features in the present invention is not limited to the combination described in the claims of the present invention or the combination described in the specific examples, and all the technical features described in the present invention can be freely combined or combined in any way unless conflict with each other.

It should also be noted that the above-mentioned examples are only specific examples of the present invention. Obviously, the present invention is not limited to the above examples, and similar variations or modifications made therewith can be directly derived or can be easily thought of by those skilled in the art from the contents disclosed in the present invention, and all belong to the protection scope of the present invention.

1. A low-cost non-oriented electrical steel plate with an extremely low aluminum content, characterized by comprising the following chemical elements in percentage by mass:
0.003% or less of C, 0.1%-1.2% of Si, 0.1%-0.4% of Mn, 0.01%-0.2% of P, 0.003% or less of S, 0.001% or less of Al, 0.003%-0.01% of O, 0.003% or less of N, and 0.005%-0.05% of Sn, with the condition Si²/P: 0.89-26.04 being satisfied.

2. The non-oriented electrical steel plate according to claim 1, characterized by comprising the following chemical elements in percentage by mass:
0.003% or less of C, 0.1%-1.2% of Si, 0.1%-0.4% of Mn, 0.01%-0.2% of P, 0.003% or less of S, 0.001% or less of Al, 0.003%-0.01% of O, 0.003% or less of N, 0.005%-0.05% of Sn, and the balance of Fe and other unavoidable impurities, with the condition Si²/P: 0.89-26.04 being satisfied.

3. The non-oriented electrical steel plate according to claim 1 or 2, characterized by comprising 0.0005% or less of Al.

4. The non-oriented electrical steel plate according to claim 1 or 2, characterized by comprising 0.045-0.007% of O.

5. The non-oriented electrical steel plate according to claim 1 or 2 characterized by comprising 0.005-0.02% of Sn.

6. The non-oriented electrical steel plate according to claim 1 or 2, characterized in that Si²/P is 0.89-16.67.

7. The non-oriented electrical steel plate according to claim 1 or 2, characterized in that compared with conventional products of a same grade, the iron loss P_{15/50} of the non-oriented electrical steel plate is reduced by 0.2-0.8 W/kg on average, and a magnetic induction B₅₀ of the non-oriented electrical steel plate is increased by 0.01-0.04 T on average.

8. A method for manufacturing the non-oriented electrical steel plate according to claim 1, characterized by comprising the steps of:
(1) smelting;
(2) continuous casting;
(3) hot rolling: wherein a hot rolled plate is subjected to soaking and heat preservation by means of residual heat of hot rolled steel coils, rather than being subjected to normalizing treatment or cover furnace annealing after coiling;
(4) primary cold rolling; and
(5) continuous annealing.

9. The manufacturing method according to claim 8, characterized in that in step (1), ferrophosphorus, ferrosilicon and ferromanganese are added in sequence during deoxidation and alloying of RH refining.

10. The manufacturing method according to claim 9, characterized in that Al≤0.1% and/or Ti≤0.03% in the ferrosilicon.

11. The manufacturing method according to claim 8, characterized in that in step (3), the initial rolling temperature is controlled to be 1050-1150° C., the finish rolling temperature is controlled to be 650-950° C., the coiling temperature is controlled to be 650-850° C., the soaking and heat preservation temperature is controlled to be 650-850° C., and the heat preservation time is controlled to be at least 10 s.

12. The manufacturing method according to claim 8 or 11, characterized in that in step (3), rough rolling and finish rolling are completed in 2 to 8 passes.

13. The manufacturing method according to claim 8, characterized in that in step (5), the annealing is performed at 650-950° C. under an annealing atmosphere of a mixed gas of H₂ and N₂, wherein a volume proportion of H₂ is 20-60%.
